(19) United States
(12) Patent Application Publication
(10) Pub. No.: US 2002/0097927 A1
(43) Pub. Date: Jul. 25, 2002

(54) Hybrid air foil journal bearing and manufacturing method thereof

(76) Inventors: Yong Bok Lee, Seoul (KR); Chang Ho Kim, Seoul (KR); Nam Soo Lee, Seoul (KR); Tae Ho Kim, Yongin (KR)

Correspondence Address: NIYOGI, Bidyut K., Suite #207, 95 Bulldog Blvd., Melbourne, FL, 32901, US

(21) Appl. No.: 09/912,965

(22) Filed: Jul. 25, 2001

(30) Foreign Application Priority Data
Jan. 19, 2001 (KR) 2001-3226

(51) Int. Cl. F16C 32/06

(52) U.S. Cl. 384/103

(57) ABSTRACT

A hybrid air foil journal bearing in accordance with the present invention, comprising an hybrid air foil journal bearing supporting a shaft by air layer formed between inner surface of the housing thereof and the shaft, wherein said bearing comprising a plurality of key slots formed on the surface of the bearing housing, which are spaced apart from each other at a certain distance, a plurality of hybrid foils formed as a body to have a high stiffness and a high resiliency supporting said shaft, which are correspondingly fixed at said key slots.

### BACKGROUND OF THE INVENTION

1. Field of the Invention

The present invention relates to pneumatic journal bearings supporting a rotating shaft of a variety of high speed rotating system, such as auxiliary power units (APU) for aircrafts or air conditioning machines (ACM) and, more particularly, to a hybrid air foil journal bearing having a hybrid foil with both a resilient multi-leaf foil and a stiff bump foil and thusly having a high supporting capacity of the shaft highly loaded and a high damping capacity, and to a manufacturing method thereof.

2. Description of the Prior Art

As well known to those skilled in the art, air foil journal bearings, or a kind of pneumatic journal bearings, have been preferably used for supporting a rotating shaft of a variety of high speed rotating system, such as auxiliary power units (APU) for aircrafts or air conditioning machines (ACM). Conventional pneumatic bearings have been designed such that pressurized air is contained in the annular gap between the shaft and the bearing housing to form an air lubrication layer, thus reducing the frictional force formed between the rotating shaft and bearing housing during an operation and improving the operational precision of the bearing, and allowing the bearing to effectively support a high bearing load. The general shape of the conventional air foil bearings is similar to that of a conventional pneumatic bearing, except that a thin foil is inserted between the shaft and the bearing housing.

FIG. 1 is a sectional view of a multi-leaf foil journal bearing having a multi-leaf foil according to a conventional art.

The conventional multi-leaf foil bearing has a plurality of key slots 12a which are formed on the inner surface of a bearing housing 12 and are spaced apart from each other by a predetermined distance. A multi-leaf foil 14 is inserted between the shaft 10 and the bearing housing 12 while being held by the key slots 12a. The multi-leaf foil 14 supports the shaft 10 with a resiliency generated by bending itself.

The multi-leaf foil bearing can reduce the vibration of the shaft because the multi-leaf foil has the bending resiliency. While the multi-leaf foil bearing has a small load-supporting capability because a stiffness of the multi-leaf-leaf foil is relatively small.

Accordingly, since it is easy to break air layer of foil bearing by external force if a load-support capability is relatively small, the conventional air foil bearing may fail to effectively support the shaft.

FIG. 2 is a sectional view of a bump foil journal bearing having a bump foil according to a conventional art.

As shown in the drawing, the conventional bump foil bearing has a bump foil 18 is arranged on the inner surface of the bearing housing 12 and a top foil 16 between a shaft 10 and the bump foil 18 supporting the shaft 10 together with the bump foil 18. Here, the bump foil 18 has a desired high stiffness, thus desirably increasing the bearing load support capacity of the air foil bearing.

However, since the resiliency of the bump foil 18 is small, even though its stiffness is large, it occurs a large vibration of the bearing when the shaft rotates fast.

### SUMMARY OF THE INVENTION

The main object of the present invention is to provide a hybrid air foil journal bearing and a manufacturing method thereof, which has a hybrid air foil with both a resilient multi-leaf foil and a stiff bump foil, thus having a high capacity of supporting a bearing load and a high damping capacity.

Another object of the present invention is to provide a hybrid air foil journal bearing and a manufacturing method thereof, which has a hybrid air foil with both a resilient multi-leaf foil and a stiff bump foil, thus having a high capacity of supporting a bearing load and a high damping capacity when a shaft rotates fast.

In order to accomplish the above objects, a hybrid air foil journal bearing in accordance with the present invention, comprising an hybrid air foil journal bearing supporting a shaft by air layer formed between inner surface of the housing thereof and the shaft, wherein said bearing comprising a plurality of key slots formed on the surface of the bearing housing, which are spaced apart from each other at a certain distance, a plurality of hybrid foils formed as a body to have a high stiffness and a high resiliency supporting said shaft, which are correspondingly fixed at said key slots.

In order to accomplish the above objects, a manufacturing method of hybrid air foil of hybrid air foil journal bearing in accordance with the present invention, wherein the method comprising the steps of forming a foil having a multi-leaf type and a bump type by pressing the foil with a press die mold, forming a fixing unit at an end of the bump type foil, which shaped as corresponding to a shape of the key slot of the journal bearing housing and bending a part between the bump type foil and a multi-leaf type foil.

### BRIEF DESCRIPTION OF THE DRAWINGS

The above and other objects, features and other advantages of the present invention will be more dearly understood from the following detailed description taken in conjunction with the accompanying drawings, in which:

FIG. 1 is a sectional view of a multi-leaf foil journal bearing having a multi-leaf foil according to a conventional art;

FIG. 2 is a sectional view of a bump foil journal bearing having a bump foil according to a conventional art;

FIG. 3 is a sectional view of a hybrid air foil journal bearing in accordance with the preferred embodiment of the present invention;

FIG. 4 is a sectional view of the hybrid air foil of the hybrid air foil journal bearing shown as in FIG. 3;

FIG. 5 is a partially sectional view of the hybrid air foil bearing when the shaft supporting load rotates according to the present invention;

FIG. 6 is a partially sectional view of the hybrid air foil bearing when the shaft supporting high load rotates according to the present invention;

FIG. 7 is a sectional view of the press die mold according to the present invention; and

FIGS. 8A to 8C are illustrated views to explain a method of manufacturing the hybrid airfoil of the hybrid air foil journal bearing according to the present invention.

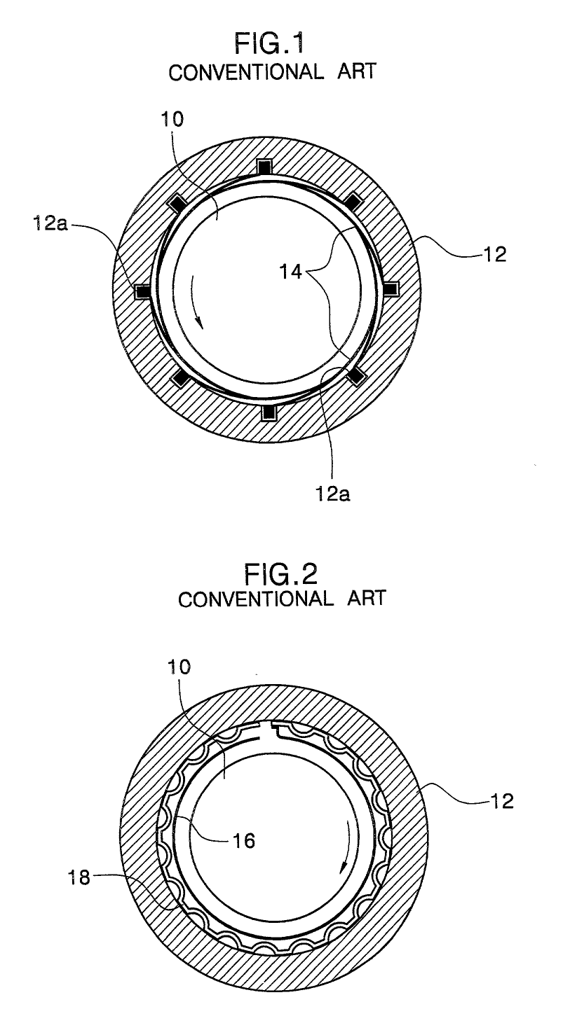

### DETAILED DESCRIPTION OF THE INVENTION

Reference now should be made to the drawings, in which the same reference numerals are used throughout the different drawings to designate the same or similar components.

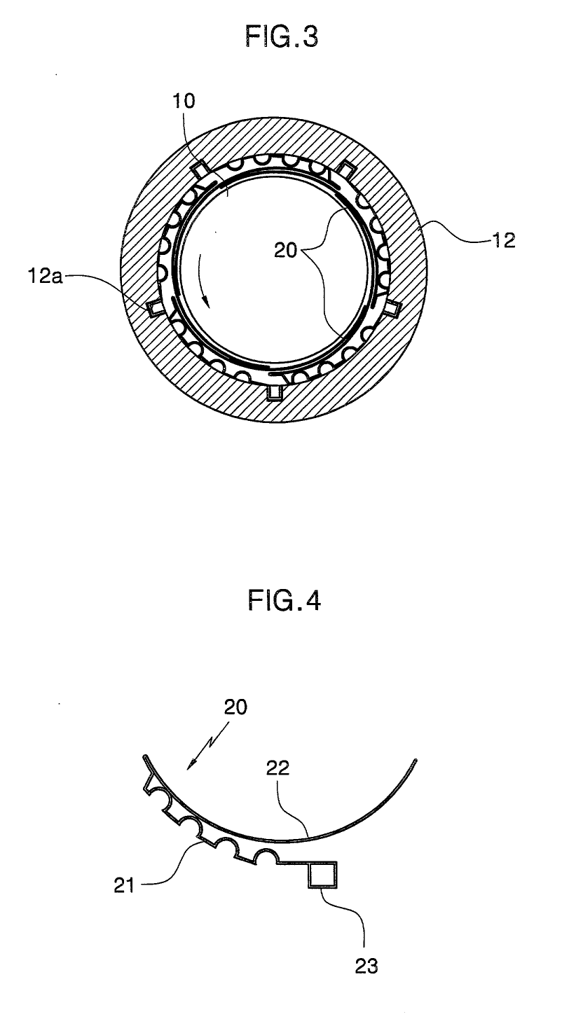

FIG. 3 is a sectional view of a hybrid air foil journal bearing in accordance with the preferred embodiment of the present invention.

As shown in the drawing, the hybrid air foil journal bearing has a plurality of key slots 12a at inner surface of the bearing housing 12 while being spaced apart from each other at a predetermined distance, and a hybrid air foil 20 installed between the inner surface of the bearing housing 12 and a shaft 10.

FIG. 4 is a sectional view of the hybrid air foil of the hybrid air foil journal bearing shown as in FIG. 3.

As shown in the drawing, the hybrid air foil has both a multi-leaf foil having a resiliency and a bump foil having a stiffness connecting with an end of the multi-leaf foil. Here the other end of the bump foil has a fixing unit, or key space, to fix the hybrid air foil to the slot 12a on the inner surface of the bearing housing 12. That is, the multi-leaf foil plays a role to increase the damping capacity of the hybrid air foil bearing and the bump foil plays a role to increase the bearing load support capacity. The operation of the hybrid air foil bearing will be explained as followings:

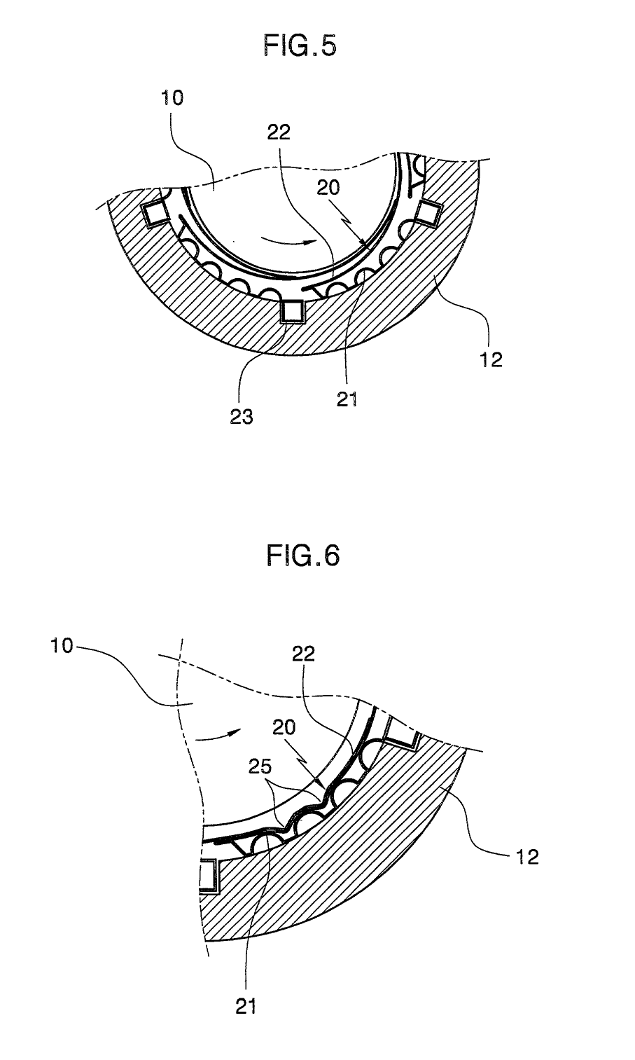

As shown in FIG. 5, which is a partially sectional view of the hybrid air foil bearing when the shaft supporting load rotates according to the present invention, the hybrid air foil bearing contacts and supports the loaded-shaft from the beginning of shaft rotation to a predetermined rotating speed of the shaft, and then supports the shaft without contacting it by hydrodynamic pressure generated between the hybrid air foil and the shaft as the shaft rotates very fast, namely the shaft rotates in buoyancy state from the hybrid air foils. Namely, the hydrodynamic pressure supporting force is larger as the rotating speed of the shaft is higher and thusly the multi-leaf foil is elastically deformed.

FIG. 6 is a partially sectional view of the hybrid air foil bearing when the shaft supporting high load rotates according to the present invention.

The hybrid air foils 20 have a plurality of stiff bump foil 21 and a plurality of resilient multi-leaf foil 22 as shown in FIG. 4, respectively. Here, the resilient multi-leaf foil 22 extend from the stiff bump foil 21, respectively. That is, the multi-leaf foil 22 is integrated into the bump foil 21 and formed to a single body. The hybrid foil 20 of this invention also has a plurality of spacer keys 23, which are provided at the outer ends of the bump foil 21 and seated in the key slots 12a of the bearing housing 12, respectively.

When the shaft 10 is rotated relative to the bearing housing 12, the multi-leaf foil 22 come into frictional contact with the outer surface of the rotating shaft 10 because an initial pneumatic pressure at the initial stage of the rotation of the shaft 10 does not exist. However, when the rotational speed of the shaft 10 becomes higher than a predetermined reference level, the shaft 10 is effectively supported without coming into frictional contact with the multi-leaf foil 22 since the multi-leaf foil parts 22 are raised from the outer surface of the shaft 10 due to dynamic buoyancy applied to the multi-leaf foil parts 22 by a dynamic pressure formed by the high speed rotation of the shaft 10. Therefore, the hybrid air foil journal bearing of this invention accomplishes a high bearing load support capacity.

The dynamic pressure applied to the multi-leaf foil 22 within the bearing housing 12 is gradually increased in proportion to the rotational speed of the shaft 10, and deforms the shape of the multi-leaf foil parts 22 as best seen in FIG. 6.

When the shaft 10 is rotated while being loaded as shown in FIG. 5, the multi-leaf foil 22 surrounding the outer surface of the shaft 10 are bent due to the dynamic pressure formed in the bearing housing 12. In such a case, the bending strain of the multi-leaf foil 22 is increased in proportion to the load applied to the bearing, and so the multi-leaf foil parts 22 more severely bias the bump foil parts 21 toward the bearing housing 12. That is, the bump foil parts 21 support the bending strain of the multi-leaf foil 22.

Therefore, when the dynamic pressure within the bearing housing 12 is increased higher than a level at which the multi-leaf foil 22 effectively endure the dynamic pressure, the multi-leaf foil 22 are elastically deformed at the gaps between the ridges of the bump foil parts 21, thus forming a plurality of grooves 25 as best seen in FIG. 6. The grooves 25 increase the dynamic pressure of the air foil bearing, and improve the bearing load support capacity of the bearing. The multi-leaf foil 22 surrounding the shaft 10 has a desirably high resiliency in comparison with the bump foil 21, and effectively attenuate vibrations of the shaft 10 during a rotation of the shaft 10, thus accomplishing a desired high damping capacity of the bearing. Due to such a high damping capacity, the bearing accomplishes a desired high operational stability.

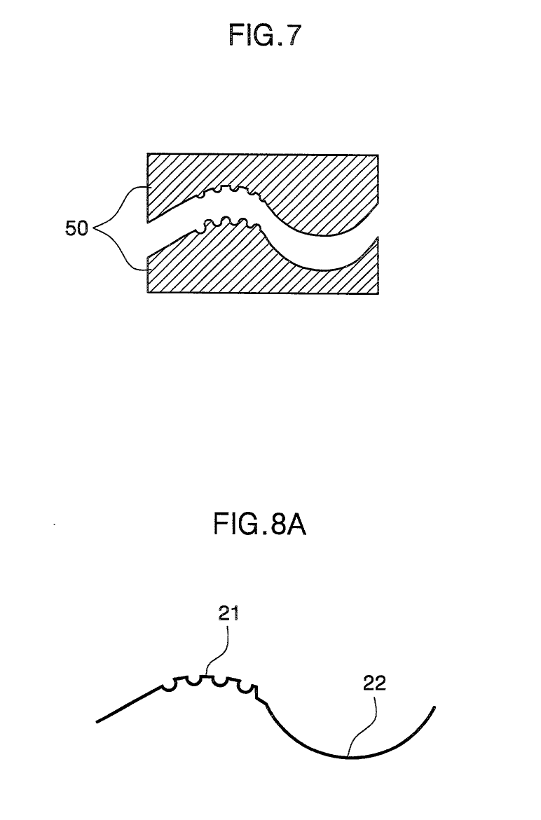

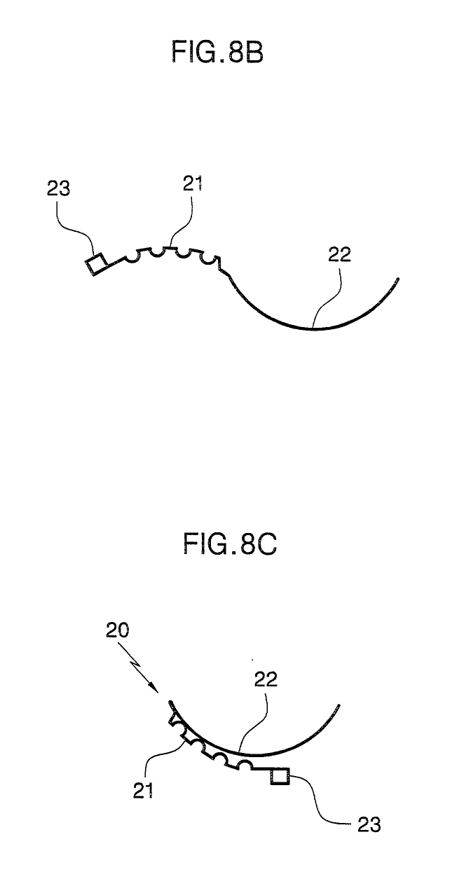

FIG. 7 is a sectional view of the press die mold according to the present invention and FIGS. 8A to 8C are illustrated views to explain a method of manufacturing the hybrid air foil of the hybrid air foil journal bearing according to the present invention.

In order to manufacture the hybrid air foil 20, it is necessary to previously provide two press die molds 50 as shown in FIG. 7. The two die molds 50 are designed to form one bump foil 21 integrated with one multi-leaf foil 22.

A thin plate, having a thickness of 0.1 mm ˜0.3 mm, is seated between the two die molds 50, and is compressed by the two die molds 50, thus forming a thin foil having both one bump foil 21 and one multi-leaf foil 22 as shown in FIG. 8A. Thereafter, the outer end of the bump foil 21 of the thin foil is processed to form a spacer key 23 at the outer end as shown in FIG. 8B prior to bending the thin foil at the junction of the two foil 21 and 22 to form a desired unit foil as shown in FIG. 8C. A predetermined number of unit foils produced through the above-mentioned process are integrated at their multi-leaf foil 22 into a single structure, thus manufacturing a desired hybrid air foil 20. Here, the bump foil 21 has a plurality of convex bodies of which shape is half sphere or wave form, which are apart from each other by a certain distance. The space between the bodies is flat plate contacting with the inner surface of the bearing housing.

The hybrid air foil 20 produced through the above-mentioned process must be subjected to appropriate post-processes, such as a heat treating process for increasing the rigidity of the hybrid air foil 20 and a surface coating process for increasing the endurance of the foil 20.

The hybrid air foil 20 having both the multi-leaf foil 22 and the bump foil 21 of this invention is easily produced through a simple process, and so it is possible to produce the hybrid air foils 20 at low cost. When the hybrid air foil 20 is installed within the pneumatic lubrication gap between the shaft 10 and the bearing housing 12 of the hybrid air foil journal bearing, the foil 20 effectively supports the rotating shaft 10 relative to the bearing housing 12 while appropriately attenuating vibrations of the shaft 10 during a high speed rotating action of the shaft 10, in addition to improving the bearing load support capacity of the bearing.

As described above, the present invention provides an air foil journal bearing, which has a hybrid foil with both a resilient multi-leaf foil part and a stiff bump foil part, thus having a highly improved capacity of supporting a bearing load, in addition to a highly improved damping capacity. The air foil journal bearing of this invention is preferably usable for supporting a rotating action of a variety of high speed rotating machines, such as a gas turbine engine for light aircraft, a gas turbine engine for automobiles, a compressor, a cryogenic expansion turbine, or a micro-turbine for power generators.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A hybrid air foil journal bearing supporting a shaft by air layer formed between inner surface of the housing thereof and the shaft, wherein said bearing comprising:
a plurality of key slots formed on the surface of the bearing housing, which are spaced apart from each other at a certain distance;
a plurality of hybrid air foils formed as a body to have a high stiffness and a high resiliency supporting said shaft, which are correspondingly fixed at said key slots.

2. The hybrid air foil journal bearing according to claim 1, wherein said hybrid air foil comprising:
a bump foil having said stiffness;
a multi-leaf foil having said resiliency connected with an end of the bump foil; and
a fixing unit formed at the other end of said bump foil.

3. The hybrid air foil journal bearing according to claim 2, wherein said multi-leaf foil of said hybrid air foil overlapping another multi-leaf foil of hybrid air foil by a certain area and supporting said rotating shaft together with said another multi-leaf foil of hybrid air foil.

4. The hybrid air foil journal bearing according to claim 2, wherein said multi-leaf foil increasing a reducing force by Coulomb friction generated at overlapped part between said multi-leaf foils of said hybrid air foils and at contact parts between said multi-leaf foil and said bump foil.

5. The hybrid air foil journal bearing according to claim 2, wherein said bump foil supporting said multi-leaf foil to radial direction of said shaft.

6. The hybrid air foil journal bearing according to claim 2, wherein said bump foil having a plurality of convex bodies by a certain distance therebetween and a flat part among said convex bodies.

7. The hybrid air foil journal bearing according to claim 6, wherein said convex bodies comprise half spheres or wave form bodies.

8. The hybrid air foil journal bearing according to claim 6, wherein said multi-leaf foil generating a hydrodynamic pressure by its own elastic deformation between tops of said half spheres of said bump foils when said rotating shaft is loaded highly and rotates.

9. A manufacturing method of hybrid air foil of a hybrid air foil journal bearing, wherein the method comprising the steps of:
forming a foil having a multi-leaf type and a bump type by pressing the foil with a press die mold;
forming a fixing unit at an end of the bump type foil, which shaped as corresponding to a shape of the key slot of the journal bearing housing; and
bending a part between the bump type foil and a multi-leaf type foil.

10. The manufacturing method of hybrid air foil according to claim 9, wherein said press die mold is previously manufactured as a prototype of the multi-leaf type foil and the bump type foil.

11. The manufacturing method of hybrid air foil according to claim 9, wherein said fixing unit of the hybrid air foil is fixed at the slot in the interior portion of the hybrid air foil.
